(19) United States
(12) Patent Application Publication
(10) Pub. No.: US 2012/0028497 A1
(43) Pub. Date: Feb. 2, 2012

(54) LOWER PROFILE CABLE CONNECTOR

(75) Inventors: PING-SHENG SU, New Taipei (TW); DOU-FENG WU, Kunshan (CN); YUAN CAO, Kunshan (CN)

(73) Assignee: HON HAI PRECISION INDUSTRY CO., LTD., New Taipei (TW)

(21) Appl. No.: 13/193,491

(22) Filed: Jul. 28, 2011

(30) Foreign Application Priority Data
Jul. 28, 2010 (CN) 201010238935.5

(51) Int. Cl. H01R 13/40; H01R 3/00

(52) U.S. Cl. 439/488; 439/625

(57) ABSTRACT

A cable connector, comprising a conductive terminal having a pin portion for mating and a connecting portion located in the rear of the pin portion, an insulator accommodating the conductive terminal and defining an exposing portion locating at the front of thereof, a shell locating at the rear of the exposing portion, a cable having a signal wire and a grounding wire, the signal wire connects to the conductive terminal and the grounding wire connects to the shell.

### FIELD OF THE INVENTION

The present invention relates to a cable connector, and more particularly to a cable connector with audio or video signal transmission.

### DESCRIPTION OF PRIOR ART

Recently, with the more frequent use of electric equipments or electric products, users often carry the electric equipments or electric products. If the product is too large, it is not convenient to carry and use it. Currently, the most common interface connector for audio or video signals transmission is RCA connector, user usually achieves audio and video signal transmission by using many connectors at the same time. However, the RCA connector is too large to be carried conveniently.

As discussed above, an improved cable connector overcoming the shortages of existing technology is needed.

### SUMMARY OF THE INVENTION

Accordingly, an object of the present invention is to provide a lower profile cable connector .

In order to achieve the above-mentioned objects, A cable connector, comprising a conductive terminal having a pin portion for mating and a connecting portion located in the rear of the pin portion, an insulator accommodating the conductive terminal and defining an exposing portion locating at the front of thereof, a shell locating at the rear of the exposing portion, a cable having a signal wire and a grounding wire, the signal wire connects to the conductive terminal and the grounding wire connects to the shell.

Other objects, features and advantages of the invention will be apparent from the following detailed description taken in connection with the accompanying drawings.

### BRIEF DESCRIPTION OF THE DRAWINGS

FIG. 1 is a perspective view of a cable connector in accordance with the present invention;

FIG. 2 is an exploded, perspective view of the cable connector shown in FIG. 1;

FIG. 3 is other exploded, perspective view of the cable connector shown in FIG. 1;

FIG. 4 is a partly exploded, perspective view of the cable connector shown in FIG. 1; and

FIG. 5 is a cross section view of the cable connector of FIG. 1 taken along line 5-5.

### DETAILED DESCRIPTION OF PREFERRED EMBODIMENTS

Reference will now be made to the drawing figures to describe the present invention in detail.

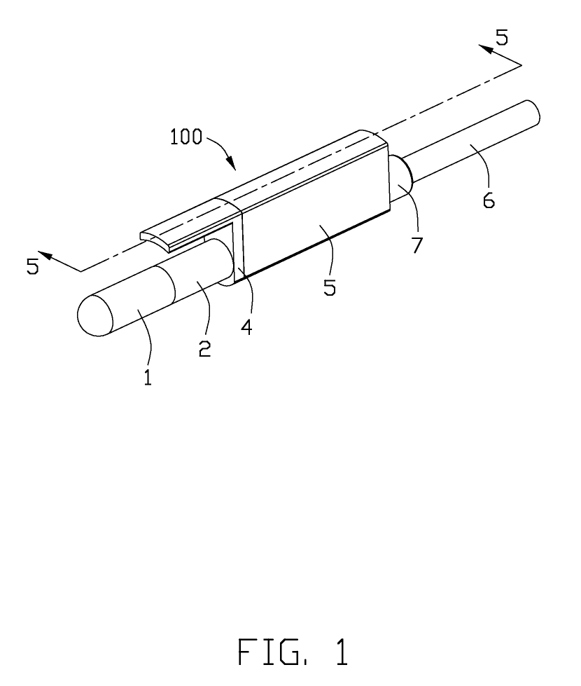

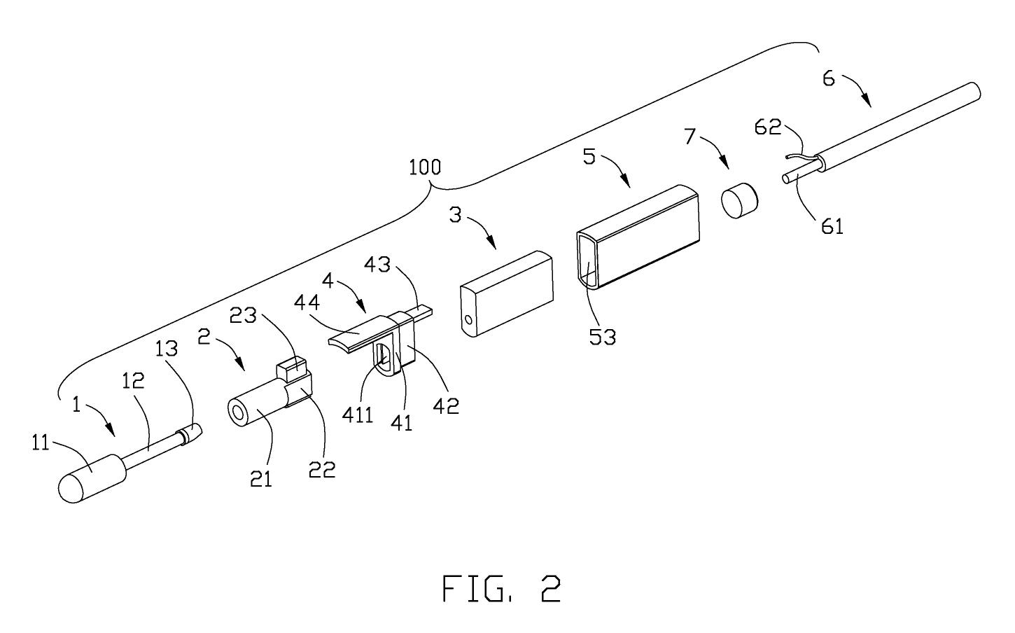

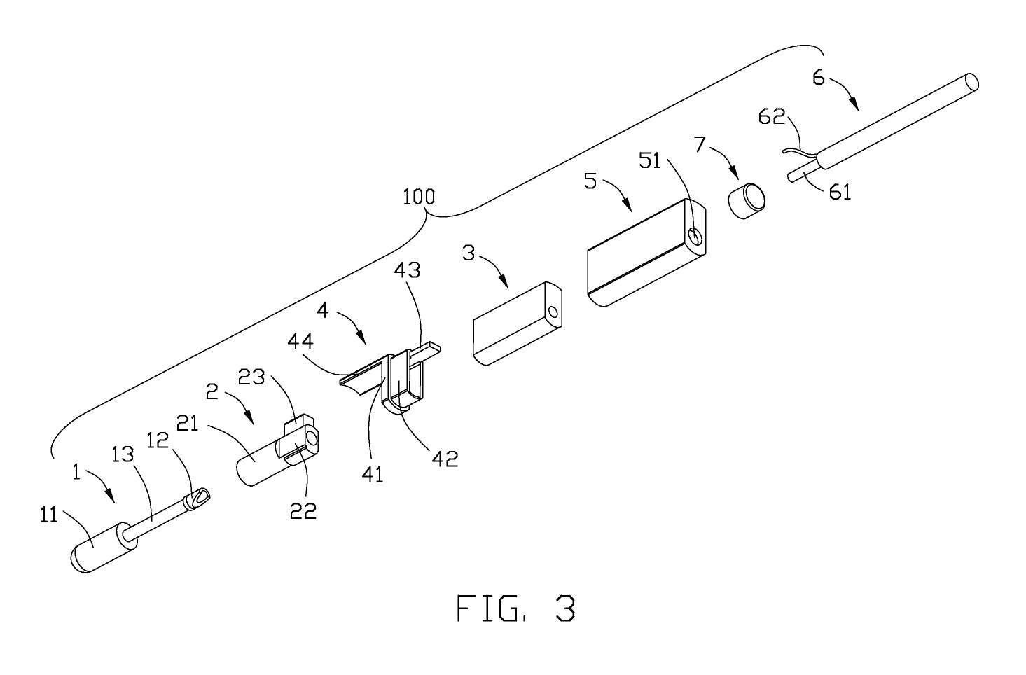

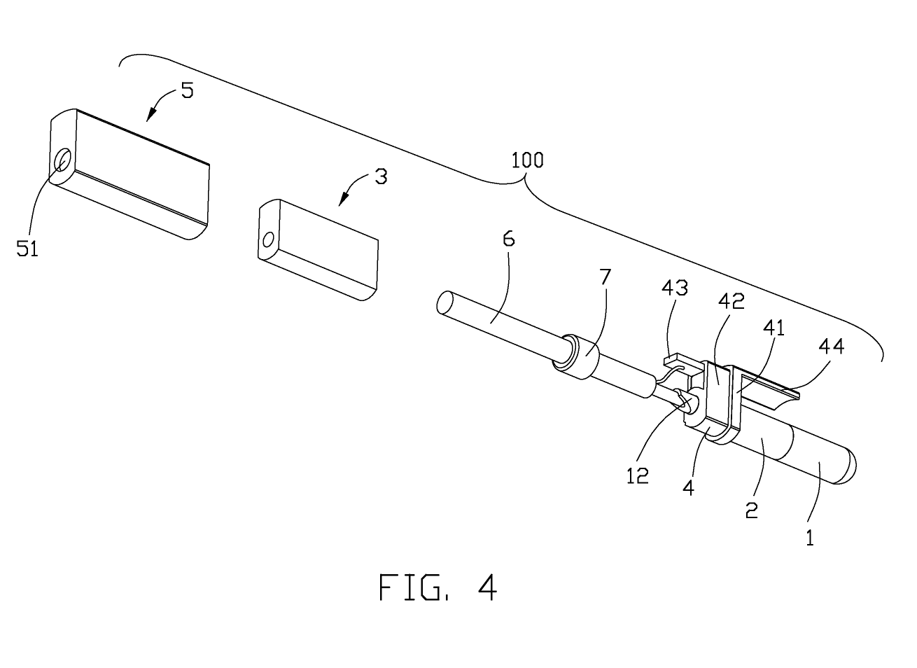

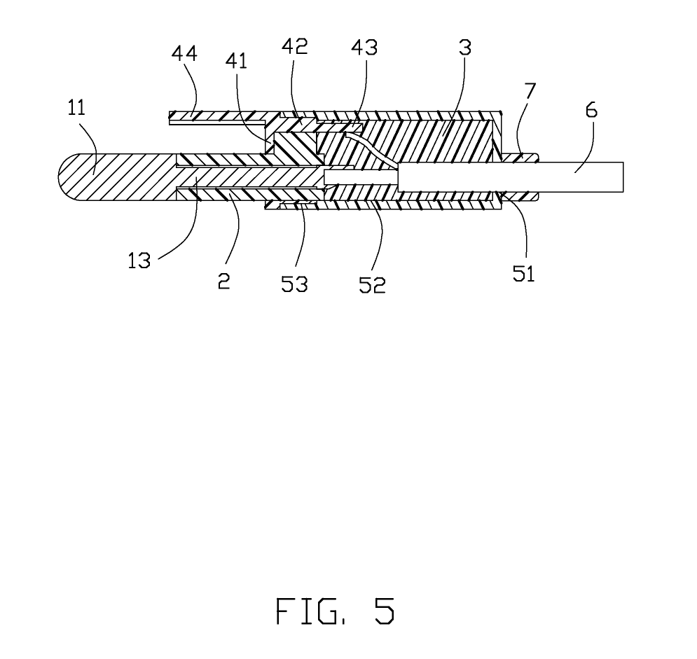

Referring to FIGS. 1 to 5, a cable assembly 100 includes a conductive terminal 1, an insulator 2 enclosing the conductive terminal 1, a front shell 4 accommodating the insulator 2, a rear shell 5 located at a rear of the front shell 4, a cable 6 connecting respectively to the conductive terminal 1 and the front shell 4, an inner-molding 3 located behind the front shell 4 and enclosing the cable 6 and a strain relief 7.

The cable 6 has two wires, one wire is a signal wire 61 and another wire is a grounding wire 62.

The conductive terminal 1 is made of the metal material, e.g. copper or other metal material. The conductive terminal 1 is cylindrical and includes a pin portion 11 for mating a complementary connector (not shown), a connecting portion 13 located on the rear of thereof and connecting signal wire 61 and an intermediate portion 12 connecting with the connecting portion 13 and the pin portion 11. The diameter of the intermediate portion 12 is smaller than the diameter of the pin portion 11 and the connecting portion 13, it makes the conductive terminal 1 and the insulator 2 connect steadily.

The insulator 2 is made of plastic, and PBT (polybutylene terephthalate) is preferred in accordance with the present invention. The insulator 2 is L-shape and completely enclosing the intermediate portion 12 of the conductive terminal 1. The insulator 2 includes a cylindrical exposing portion 21, an engagement portion 22 extending backwardly from the exposing portion 21 and a convex 23 extending upwardly from the upper surface of the engagement portion 22. The outer surface of the exposing portion 21 and the pin potion 11 are alignment.

The front shell 4 is made of the metal material, e.g. Zinc Alloy or other metal. The front shell 4 includes a main portion 41, a ring step portion 42 extending backwardly from the rear surface of the main portion 41, a connecting portion 43 extending backwardly from the step portion 42 and connected to the grounding wire 62 of the cable 6 and an inserting portion 44 for guiding and protection extending forwardly from the front surface of the main portion 41 and can insert the complementary connector (not shown). The left and right sides surface of the main portion 41 and the step portion 42 are plane, and the upper and lower surface of the main portion 41 and the step portion 42 are arc. The inserting portion 44 is an arc sheet shape and locates at a side of the conductive terminal 1 and partially surrounds conductive terminal 1. In other implementations, the inserting portion 44 may be a pair or more and locates respectively at two side of the conductive terminal 1. From the front view, the main portion 41 and the inserting portion 44 is flat shape. The main portion 41 has a through hole 411 passing through the front and rear surface thereof and communicating with the step portion 42.

The inner-molding 3 is made of the plastic and rectangular shape, and PE (polyethylene) is preferred in accordance with the present invention. The upper and lower surface of inner-molding 3 is arc and the left and right sides thereof are plane. The inner-molding 3 encloses the connecting portion 13 of the conductive terminal 1 and the front shell 4.

The rear shell 5 is made of the metal material, e.g. Zinc Alloy or other metal. The rear shell 5 defines a through hole 51 passed through the cable 6 and located on the rear surface thereon, a receiving space 52 accommodating the inner-molding 3 and a receiving slit 53 recessed backwardly from the front surface thereon and connecting to the step portion 42 of the front shell 4. The shape of the rear shell 5 is the same as the front shell 4, the upper and lower surfaces are arc and the left and right sides of he rear shell 5 are plane. The rear shell 5 and the front shell 4 collectively refer to a shell.

The strain relief 7 is molded on the outer surface of the cable 6 and located at the rear of the rear shell 5. The material is PVC (poly vinylchloride) in accordance with the present invention.

Assembling, the insulator 2 is molded on the conductive terminal 1 and the front shell 4 at same time for retention steady the conductive terminal 1 and the front shell 4. The insulator 2 fills with the intermediate portion 12 of the conductive terminal 1 and the exposing portion 21 of the insulator 2 located at the front of the main portion 41 of the front shell 4, the engagement portion 22 and the convex 23 accommodate in the step portion 42, the connecting portion 13 of the conductive terminal 1 exposes the rear surface of the insulator 2, the inserting portion 44 locates at a side of the conductive terminal 1 and surrounds the conductive terminal 1, the non-surrounding space of the exposing portion 21 is open. The cable connector 100 transmit the audio and video signal in accordance with of the present invention, it can replace the existing RCA connector and match the existing RCA socket of the products. The different color of the exposing portion 21 of the insulator 2 which replaces the existing RCA cable connector which the color of its insulator 2 is different in different signal cable connector can discriminate different signal.

The signal wire 61 of the cable 6 solders on the connecting portion 13 of the conductive terminal 1 and the grounding wire 62 solders on the connecting portion 43 of the front shell 4. Molding, the inner-molding 3 encloses the connecting portion 13 the conductive terminal 1, the connecting portion 42 of the front shell 4 and the cable 6. The cable 6 passes through the through hole 51, the receiving slit 53 of the rear shell 5 accommodates the step portion 42 of the front shell 4, the receiving space 52 of the rear shell 5 accommodates the inner-molding 3. The connection between the receiving slit 53 and the step portion 42 is steady by the way of glue or interference. The strain relief 7 encloses the cable 6 and is adjacent to the rear surface of the rear shell 5.

It will be understood that the invention may be embodied in other specific forms without departing from the spirit or central characteristics thereof The present examples and embodiments, therefore, are to be considered in all respects as illustrative and not restrictive, and the invention is not to be limited to the details given herein.

What is claimed is:

1. A cable connector, comprising:
a conductive terminal having a pin portion for mating and a connecting portion located in the rear of the pin portion;
an insulator accommodating the conductive terminal and defining an exposing portion locating at the front of thereof;
a shell locating at the rear of the exposing portion;
a cable having a signal wire connected to the conductive terminal and a grounding wire connected to the shell.

2. The cable connector as recited in claim 1, wherein the insulator defines a front shell including a main portion enclosing the insulator and an inserting portion extending forwardly from the front surface of the main portion and partially surrounding partly the conductive terminal and a rear shell connecting to the front shell.

3. The cable connector as recited in claim 2, wherein the front shell is flat shape, the upper and lower surfaces of the front shell are arc, and the left and right side surfaces of the front shell therein are plane.

4. The cable connector as recited in claim 3, wherein the inserting portion locating at a side of the conductive terminal, the non-surrounding space of the exposing portion is open.

5. The cable connector as recited in claim 3, wherein the outer surface of the exposing portion and the outer surface of the pin portion are alignment with each other.

6. The cable connector as recited in claim 5, wherein the insulator is molded on the conductive terminal and the front shell at same time.

7. The cable connector as recited in claim 6, wherein the front shell also includes a step portion connect to the rear shell and a connecting portion extending backwardly from the step portion, and the grounding wire connects the connecting portion.

8. The cable connector as recited in claim 7, wherein the cable connector also includes an insert-molding enclosing the connecting portion of the conductive terminal and the front shell.

9. The cable connector as recited in claim 8, wherein the rear shell defines a receiving slit accommodating the step portion.

10. The cable connector as recited in claim 9, wherein the connection of the receiving slit and the step portion is interference.

11. The cable connector as recited in claim 9, wherein there is some glue applied between the receiving slit and the step portion.

12. The cable connector as recited in claim 1, wherein some of the exposing portion of the insulator of many cable connectors defining different color discriminates different video or audio cable connectors with the color.

13. A cable connector comprising:
an insulator including a front cylindrical tubular exposing portion and rear engaging portion;
a metallic shell receiving said rear engaging portion therein;
a conductive terminal including a front mating pin portion and an intermediate portion behind the front mating pin portion wherein the pin portion is diametrically larger the intermediate portion under condition that the pin portion is diametrically similar to the exposing portion and the intermediate portion is received in the exposing portion; wherein
the insulator is forwardly assembled to the shell while the terminal is rearwardly assembled to the insulator.

14. The cable connector as claimed in claim 13, wherein the shell defines an axially forwardly extending inserting portion which is radially spaced from the exposing portion while terminating at a similar axial position with the exposing portion.

15. The cable connector as claimed in claim 13, wherein the terminal further includes a connecting portion, at a rear end, connected to a signal wire of a cable, and the shell further includes a rearwardly extending connecting portion connected to a grounding wire of said cable.

16. The cable connector as claimed in claim 15, further including another metallic shell grasping upon a rear end region of the shell and enclosing an inner molding part which encloses both said signal wire and said grounding wire therein and intimately forwardly and axially confronts the insulator.

17. The cable connector as claimed in claim 13, wherein the shell defines a rectangular like configuration with a long side and a short side thereof under condition that a dimension of the short side is slightly larger than a diameter of the exposing portion.

18. A cable connector comprising:
a first metallic shell defining a ring portion;
an insulator defining an engagement portion received in the ring portion;
a terminal axially extending through the shell with a rear end connected to a signal wire of a cable; and
a grounding wire of said cable connected to the shell; wherein
the ring portion defines a racetrack like configuration with a long side and a short side thereof under condition that the terminal is located adjacent to one longitudinal end of said long side, and the shell further includes an inserting portion located around an opposite longitudinal end and axially extending forwardly in a parallel relation with the terminal.

19. The cable connector as claimed in claim 18, wherein the shell further includes a connecting portion located around one of said two opposite longitudinal ends to connect to said ground wire.

20. The cable connector as claimed in claim 18, further including another shell cooperating with said shell to commonly sandwich a portion of an inner molding which fills an interior of said another shell to bind the signal wire and the grounding wire.
